(19) United States
(12) Patent Application Publication
(10) Pub. No.: US 2020/0184029 A1
(43) Pub. Date: Jun. 11, 2020

(54) SIMULATION APPARATUS, SIMULATION METHOD, AND NON-TRANSITORY COMPUTER READABLE MEDIUM STORING PROGRAM

(71) Applicant: SUMITOMO HEAVY INDUSTRIES, LTD., Tokyo (JP)

(72) Inventor: Kiminori Sakai, Chiba (JP)

(21) Appl. No.: 16/588,493

(22) Filed: Sep. 30, 2019

(30) Foreign Application Priority Data
Dec. 11, 2018 (JP) 2018-231799

(51) Int. Cl. G06F 17/50; G06T 17/20

(52) U.S. Cl. CPC G06F 17/5009; G06T 17/20

(57) ABSTRACT

An input unit that receives shape definition data that defines a shape of a simulation target object and a mesh division condition relating to a mesh size when a mesh division of the simulation target object is performed. A processing unit performs the mesh division of the simulation target object based on the shape definition data and the mesh division condition which are input to the input unit and disposes a particle at a node of a generated mesh to perform time evolution of a state of the particle based on an interaction potential between the particles. The processing unit varies a time step width for the time evolution of the state of the particle according to a distance between the particles.

### RELATED APPLICATIONS

The content of Japanese Patent Application No. 2018-231799, on the basis of which priority benefits are claimed in an accompanying application data sheet, is in its entirety incorporated herein by reference.

### BACKGROUND

### Technical Field

Certain embodiment of the present invention relates to a simulation apparatus, a simulation method, and a non-transitory computer readable medium storing a program.

### Description of Related Art

In mechanical structure analysis using dynamic explicit methods such as molecular dynamics method and renormalization group molecular dynamics method, it is preferable to perform time evolution with a time step width or less according to a mesh size (interparticle distance) in order not to diverge a calculation. The smaller the mesh size (the shorter the interparticle distance), the smaller a preferred time step width. When the mesh size of a system to be analyzed differs depending on a location, the time step width is required to be reduced according to the smallest mesh size in the system. For the reason, a calculation amount increases and an analysis time becomes longer.

The related art discloses a living body simulation apparatus that performs analysis by coupling molecular motion in a sarcomere and a muscle continuum model. A time step width in the Monte Carlo simulation processing of the sarcomere model is different from a time step width in a finite element analysis of the continuum model.

### SUMMARY

According to an embodiment of the present invention, there is provided a simulation apparatus including: an input unit that receives shape definition data that defines a shape of a simulation target object and a mesh division condition relating to a mesh size when a mesh division of the simulation target object is performed; and a processing unit that performs the mesh division of the simulation target object based on the shape definition data and the mesh division condition which are input to the input unit and disposes a particle at a node of a generated mesh to perform time evolution of a state of the particle based on an interaction potential between the particles. The processing unit varies a time step width for the time evolution of the state of the particle according to a distance between the particles.

According to another aspect of the invention, there is provided a simulation method including: performing a mesh division of a shape of a simulation target object and disposing a particle at a node of a generated mesh; and varying a time step width for time evolution of a state of the particle according to a distance between the particles to perform the time evolution of the state of the particle based on an interaction potential between the particles.

According to yet another aspect of the invention, there is provided a non-transitory computer readable medium storing a program that causes a computer to execute a process. The process includes a function of acquiring shape definition data that defines a shape of a simulation target object and a mesh division condition relating to a mesh size when a mesh division of the simulation target object is performed; a function of performing the mesh division of the simulation target object based on the shape definition data and the mesh division condition which are input to the input unit and disposing a particle at a node of a generated mesh to perform time evolution of a state of the particle based on an interaction potential between the particles; and a function of varying a time step width for the time evolution of the state of the particle according to a distance between the particles.

### BRIEF DESCRIPTION OF THE DRAWINGS

FIG. 1 is a block diagram of a simulation apparatus according to an embodiment.

FIG. 2 is a flowchart of a simulation method according to the embodiment.

FIG. 3 is a graph showing an example of a relationship between a natural period P and a time step width Δt.

FIG. 4 is a timing chart for executing a first loop L1 to a fourth loop L4.

FIG. 5 is a diagram showing an example of a plurality of particles disposed at a plurality of nodes of a mesh generated from a shape of a simulation target object.

FIG. 6 is a flowchart showing a detailed procedure of step S6 (FIG. 2).

FIG. 7 is a flowchart showing a procedure of processing of the first loop L1 (step S67 in FIG. 6).

FIG. 8A is a flowchart showing a processing procedure of step S66 (FIG. 6), and FIG. 8B is a flowchart showing a processing procedure of step S64 (FIG. 6).

FIG. 9 is a flowchart showing a processing procedure of step S62 (FIG. 6).

FIG. 10A is a diagram showing shape models of two objects to be simulated, and FIG. 10B is a diagram showing shape models in a state where the two objects are in contact with each other.

FIG. 11A is a schematic perspective view of a verification model, and FIG. 11B is a graph showing a simulation result of a temporal change in a position of an unfixed end portion of the verification model.

FIG. 12 is a graph showing calculation times per one time step required for an intra-object interaction calculation and a position and velocity calculation in comparison between the embodiment and a comparative example.

### DETAILED DESCRIPTION

In the example of the related art, the time step width in the finite element analysis of the continuum model using the dynamic explicit method is constant regardless of the mesh size of the continuum model. For the reason, it is required to reduce the time step width corresponding to the smallest mesh size, and thus it is difficult to reduce the analysis time.

There is a need for providing a simulation apparatus, a simulation method, and a non-transitory computer readable medium storing a program capable of reducing an analysis time.

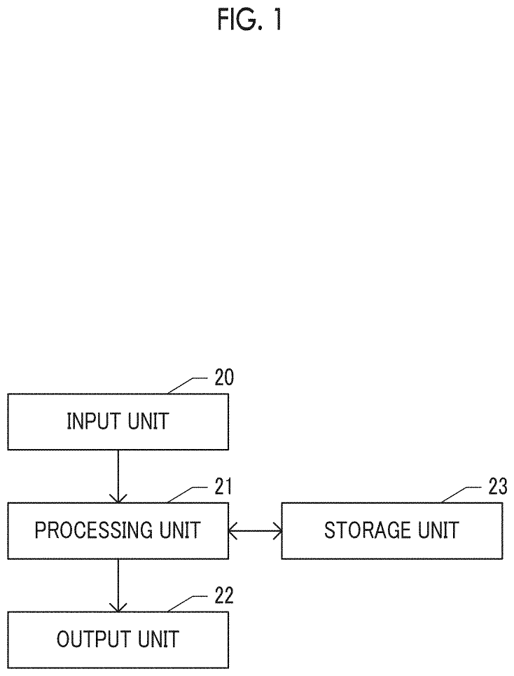

Next, a simulation apparatus and a simulation method according to an embodiment will be described with reference to FIGS. 1 to 12.

FIG. 1 is a block diagram of the simulation apparatus according to the embodiment. The simulation apparatus according to the embodiment includes an input unit 20, a processing unit 21, an output unit 22, and a storage unit 23. A simulation condition and the like are input from the input unit 20 to the processing unit 21. Further, various commands are input from an operator to the input unit 20. The input unit 20 is composed of, for example, a communication apparatus, a removable media reading apparatus, and a keyboard.

The processing unit 21 performs a mesh division of a shape of a simulation target object based on an input simulation condition and command and virtually disposes a particle at a node of a mesh to perform a simulation by a molecular dynamics method. Further, a simulation result is output to the output unit 22. The simulation result includes information representing a temporal change in the shape of the simulation target object. The processing unit 21 includes, for example, a computer, and a program for causing the computer to execute the simulation by the molecular dynamics method is stored in the storage unit 23. The output unit 22 includes a communication apparatus, a removable media writing apparatus, a display, and the like.

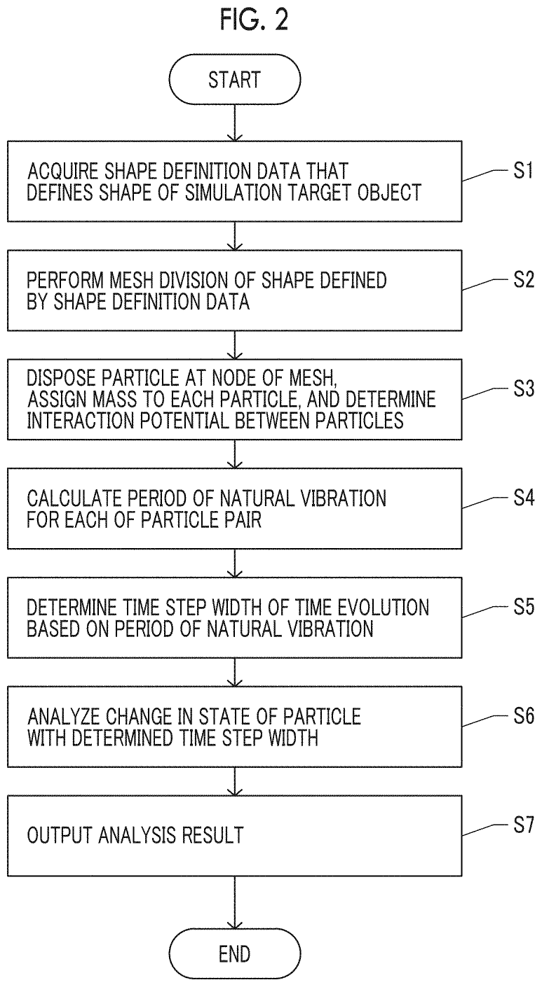

FIG. 2 is a flowchart of the simulation method according to the embodiment. The processing of each step shown in FIG. 2 is realized by the processing unit 21 (FIG. 1) executing the program stored in the storage unit 23.

First, the processing unit 21 acquires shape definition data that defines the shape of the simulation target object, physical property values (physical property values representing density, degree of elasticity, and the like) of the simulation target object, an initial condition, boundary condition, mesh division condition, and the like of the simulation (step S1). These pieces of data are input to the input unit 20 and are acquired by the processing unit 21 from the input unit 20. When the shape definition data is acquired, the processing unit 21 performs the mesh division of the shape defined by the shape definition data based on a mesh division condition to generate a shape model (step S2). For example, a known mesh division algorithm can be used for the mesh division processing. In the embodiment, the simulation target object is divided into tetrahedral meshes.

When the mesh is generated, the processing unit 21 virtually disposes the particle at the node of the mesh, assigns mass to each particle, and determines an interaction potential between the particles (step S3). The mass of the particle is determined such that the density of the shape model is the same as the density of the simulation target object based on, for example, the density of the simulation target object and the particle distribution. For example, when the density of the simulation target object is uniform, the mass of the particle is relatively small in a region where the particle distribution density is high, and the mass of the particle is relatively large in a region where the particle distribution density is low.

For example, the potential of a spring-mass model is used as the interaction potential between the particles. A method of determining a spring constant is described in detail in, for example, Japanese Unexamined Patent Publication No. 2009-37334. Here, the method of determining the spring constant will be briefly described.

First, a Voronoi polyhedron analysis is performed on the particle disposed at the node of the tetrahedral mesh. An area of an interface crossing a line segment with particles i and j as both ends of a plurality of interfaces constituting the Voronoi polyhedron is represented by Sᵢⱼ. It is possible to determine a spring constant kᵢⱼ from a Young's modulus and the area Sᵢⱼ of the simulation target object.

Next, a period of a natural vibration (natural period) is calculated for each of two particles (particle pair) connected to each other by a spring (step S4). In general, since the pieces of mass of two particles constituting a particle pair are not the same, the natural period in a state where one particle is fixed is different from the natural period in a state where the other particle is fixed. For example, a shorter natural period value of the two natural periods is employed as the natural period of the particle pair.

Based on the natural period calculated in step S4, the processing unit 21 determines, for each particle pair, a time step width when time evolution of a state of the particle is calculated (step S5). The shorter the natural period, the more the state of the particle changes in a constant time. In order to analyze the change in the state of the particle with high accuracy, the time step width may be reduced as the natural period is shorter. For example, the time step width may be selected from a range of 1/20 or more to 1/10 or less of the natural period. A plurality of time step widths are defined for one shape model.

When the time step width is determined, the processing unit 21 analyzes the change in the state of the particle with the determined time step width (step S6). Specifically, an equation of motion is solved to obtain the temporal change in the velocity and position of the particles. When the analysis ends, the analysis result is output to the output unit 22 (FIG. 1) (step S7).

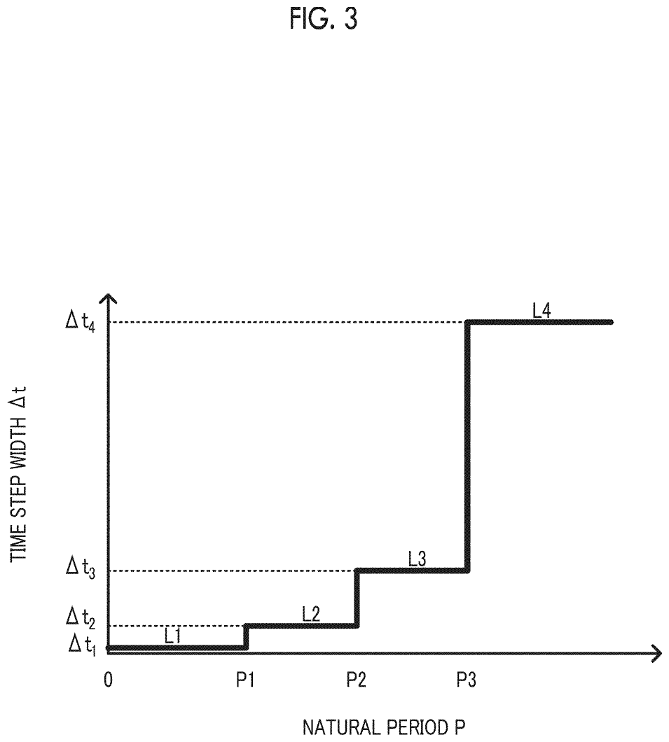

FIG. 3 is a graph showing an example of a relationship between a natural period P and a time step width Δt. The horizontal axis represents the natural period P, and the vertical axis represents the time step width Δt. For example, when the natural period P is less than P1, equal to or larger than P1 and less than P2, equal to or larger than P2 and less than P3, and equal to or larger than P3, the time step width Δt is respectively set to Δt₁, Δt₂, Δt₃, and Δt₄. Here, a magnitude relationship of Δt₁<Δt₂<Δt₃<Δt₄ is established. Further, Δt₄ is an integer multiple of Δt₃, Δt₃ is an integer multiple of Δt₂, and Δt₂ is an integer multiple of Δt₁.

For a particle pair having a natural period P of P3 or more, processing of a fourth loop L4 is executed with the time step width Δt₄ to perform the calculation of a force acting between the particles and the time evolution of the velocity. For a particle pair having the natural period P of P2 or more and less than P3, processing of a third loop L3 is executed with the time step width Δt₃. For a particle pair having the natural period P of P1 or more and less than P2, processing of a second loop L2 is executed with the time step width Δt₂. For a particle pair whose natural period P is less than P1, processing of a first loop L1 is executed with the time step width Δt₁.

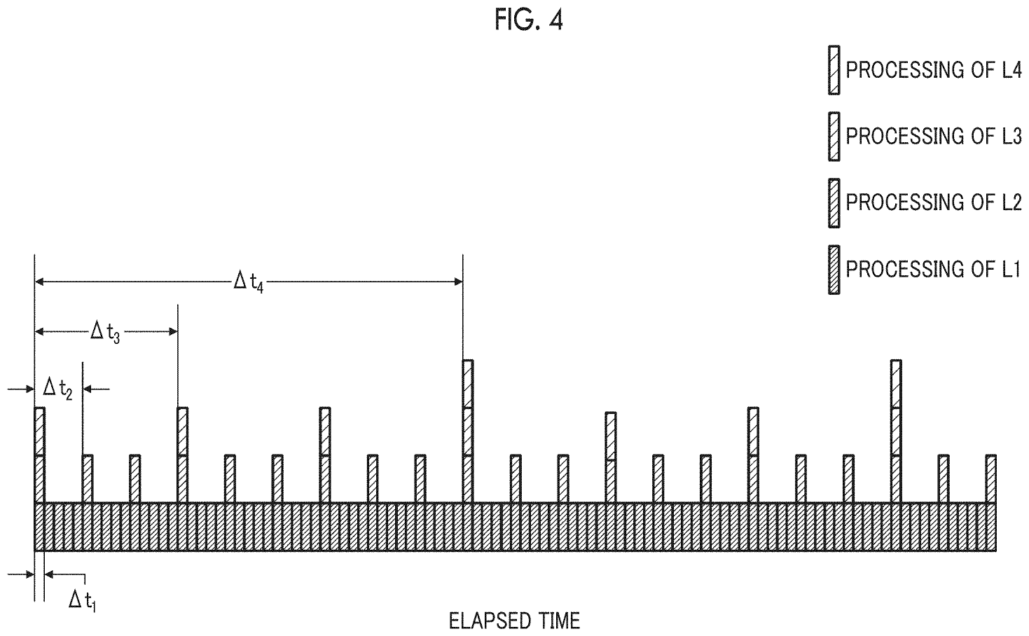

FIG. 4 is a timing chart for executing the first loop L1 to the fourth loop L4. The processing of the first loop L1 is executed for each time step width Δt₁. In other words, when the processing of the first loop L1 is executed once, the time evolution is performed by the time step width Δt₁. The processing of the second loop L2 is executed every time the accumulation of the time evolution increases by the time step width Δt₂. The processing of the third loop L3 is executed every time the accumulation of the time evolution increases by the time step width Δt₃. The processing of the fourth loop L4 is executed every time the accumulation of time evolution increases by the time step width Δt₄. One time of processing of performing the time evolution by the time step width Δt₁ is referred to as one time step.

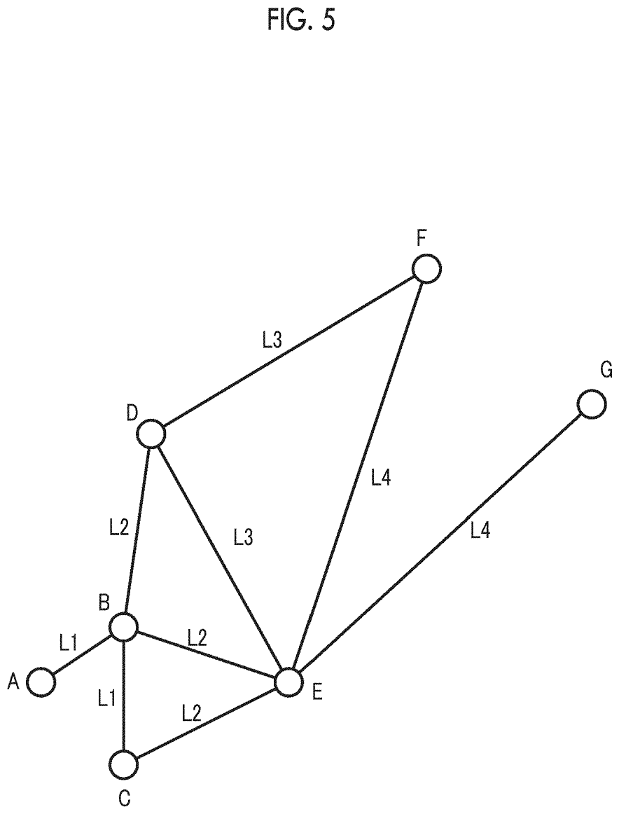

FIG. 5 is a diagram showing an example of a plurality of particles disposed at a plurality of nodes of the mesh generated from the shape of the simulation target object. A plurality of particle pairs are defined from the plurality of particles shown in FIG. 5, and any one of the first loop L1 to the fourth loop L4 is associated with each of the plurality of particle pairs based on the natural period. For example, the first loop L1 is associated with particle pairs AB and BC. The second loop L2 is associated with particle pairs BD, BE, and CE. The third loop L3 is associated with particle pairs DE and DF. The fourth loop L4 is associated with particle pairs EF and EG.

In the time step in which only the first loop L1 (FIG. 4) is executed, the time evolution of the velocity of the particles and the calculation of the force are performed for the particle pairs AB and BC. In the time step in which the first loop L1 and the second loop L2 (FIG. 4) are executed, the time evolution of the velocity of the particles and the calculation of the force are also performed for the particle pairs BD, BE, and CE. In the time step for executing the first loop L1, the second loop L2, and the third loop L3 (FIG. 4), the time evolution of the velocity of the particles and the calculation of the force are also performed for the particle pairs DE and DF. In the time step in which all the first loop L1 to the fourth loop L4 are executed, the time evolution of the velocity of the particles and the calculation of the force are also performed for the particle pairs EF and EG.

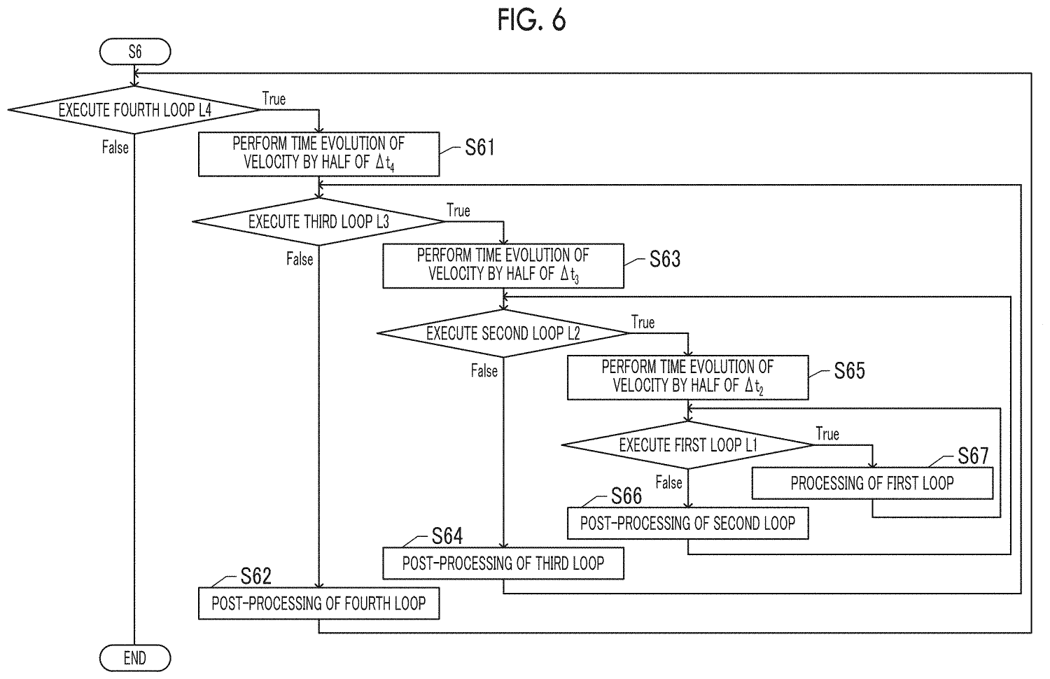

FIG. 6 is a flowchart showing a detailed procedure of the processing of analyzing the change in the state of the particle (step S6 in FIG. 2). In the following description, FIG. 5 will be referred to as appropriate.

The processing of the fourth loop L4 is executed until a calculation end condition of the simulation is satisfied. As the calculation end condition, for example, the number of time steps, the calculation time, and the like are provided. When the calculation end condition is not satisfied, first, the equation of motion is solved for the particles E, F, and G included in the particle pairs EF and EG (FIG. 5) to be processed in the fourth loop L4 to perform the time evolution of the velocity of each particle by half of the time step width Δt₄ (step S61).

After step S61 is executed, the equation of motion is solved for the particles D, E, and F included in the particle pairs DE and DF (FIG. 5) to be processed in the third loop L3 to perform the time evolution of the velocity of each particle by half of the time step width Δt₃ (step S63). Here, the time evolution of the latest velocity after the time evolution is further performed for the particles on which the time evolution of velocity is performed in step S61, for example, the particles E and F. Similarly, the time evolution of the latest velocity is further performed also in the subsequent processing of the time evolution of the velocity.

After step S63 is executed, the equation of motion is solved for the particles B, C, D, and E included in the particle pairs BD, BE, and CE (FIG. 5) to be processed in the second loop L2 to perform the time evolution of the velocity of each particle by half of the time step width Δt₂ (step S65).

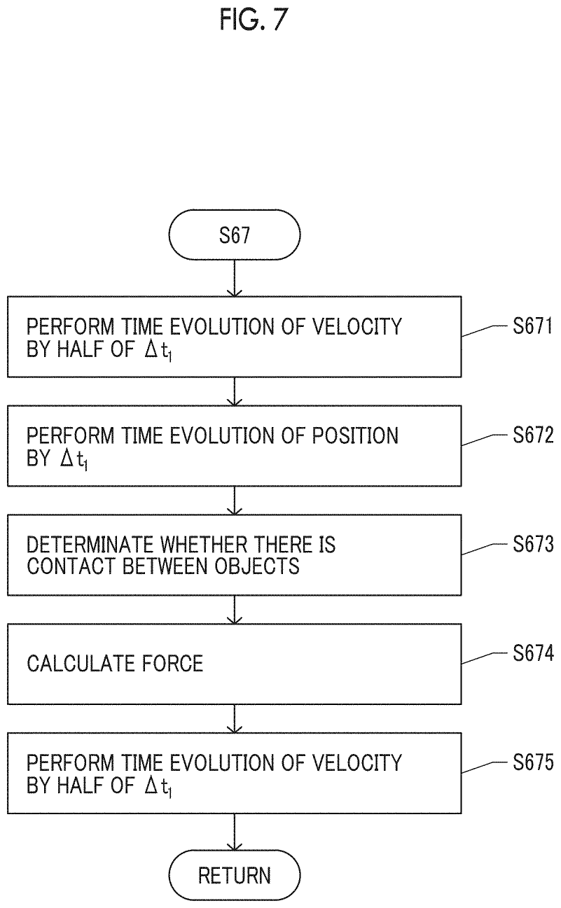

After step S65 is executed, the processing of the first loop L1 is executed for all the particles (step S67). Details of the processing of the first loop L1 will be described below with reference to FIG. 7.

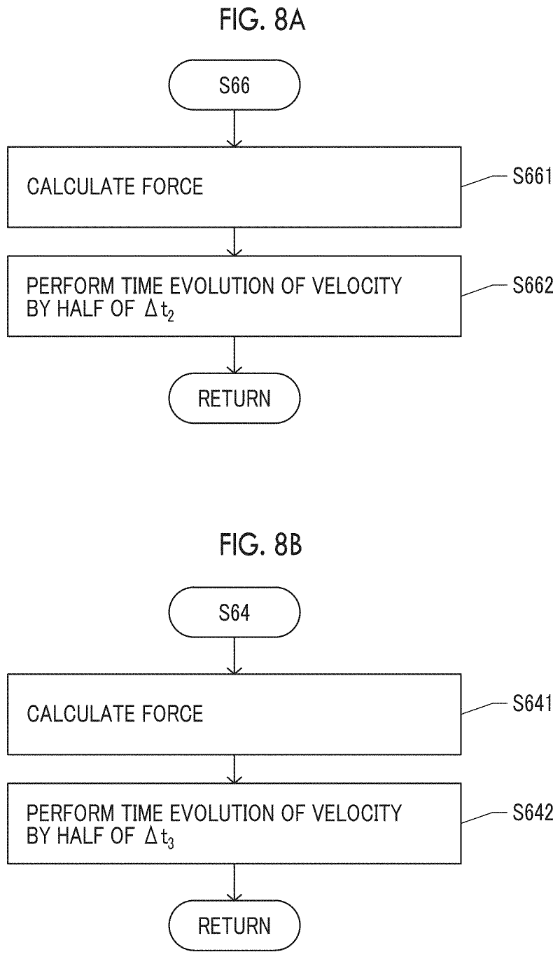

When the processing (time step) of the first loop L1 is repeated a plurality of times and an accumulated value of the time evolution after step S65 increases by Δt₂, post-processing of the second loop L2 is executed (step S66). In the post-processing of the second loop L2 (step S66), the time evolution of the velocity is further performed by half of the time step width Δt₂. The post-processing of the second loop L2 (step S66) will be described in detail below with reference to FIG. 8A. As described above, the method of executing the time evolution of the velocity by half of the time step width is referred to as a velocity Verlet method.

When the processing of the second loop L2 is repeated a plurality of times and the accumulated value of the time evolution after step S63 increases by Δt₃, the post-processing of the third loop L3 is executed (step S64). In the post-processing of the third loop L3 (step S64), the time evolution of the velocity is further performed by half of the time step width Δt₃. The post-processing of the third loop L3 (step S64) will be described in detail below with reference to FIG. 8B.

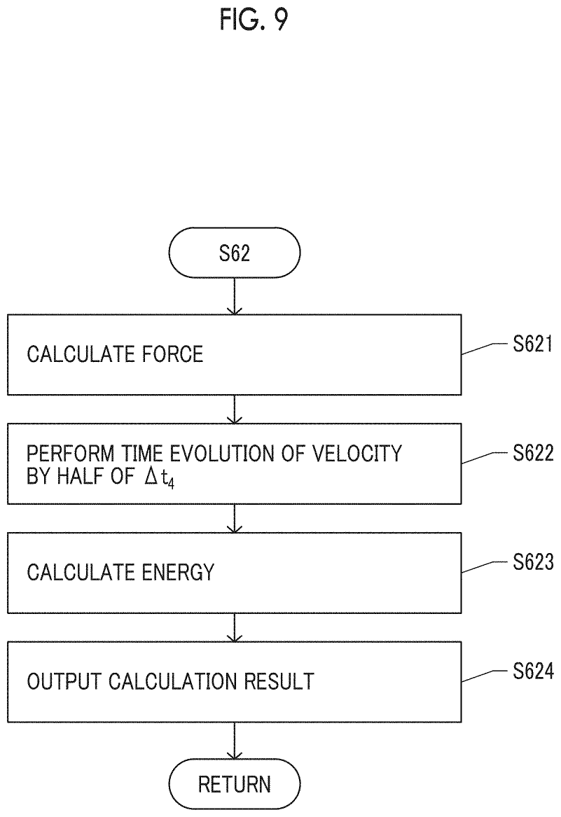

After the processing of the third loop L3 is repeated a plurality of times, when the accumulated value of the time evolution after step S61 increases by Δt₄, the post-processing of the fourth loop L4 is executed (step S62). In the post-processing of the fourth loop L4 (step S62), the time evolution of the velocity is further performed by half of the time step width Δt₄. The post-processing of the fourth loop L4 (step S62) will be described in detail below with reference to FIG. 9.

FIG. 7 is a flowchart showing a procedure of the processing of the first loop L1 (step S67 in FIG. 6). First, the equation of motion is solved for the particles A, B, and C included in the particle pairs AB and BC (FIG. 5) to be processed in the first loop L1 to perform the time evolution of the velocity of each particle by half of the time step width Δt₁ (step S671). Next, the time evolution of the positions of all the particles is performed by the time step width Δt₁ based on the latest velocity of each particle (step S672).

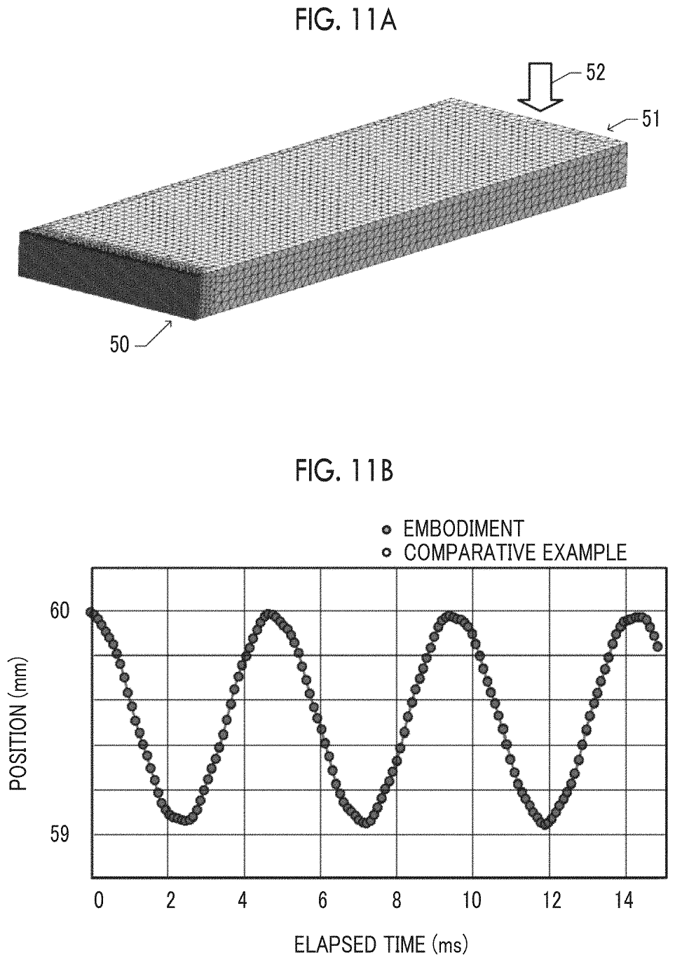

After the time evolution of the positions of all the particles is performed, determination is made whether there is a contact between objects (step S673). For example, when the simulation target object is composed of a plurality of objects, the force based on the interaction potential determined in step S3 (FIG. 2) acts between particles in the same object. The force does not act between particles of different objects in a state where the objects are not in contact with each other. However, when two objects are in contact with each other, the force is exerted between particles positioned at a contact point of the objects. When determination is made in step S673 that there is a contact between the objects, in the next time step, the interaction potential acting between particles of different objects is introduced to perform the time evolution of the velocity and position for the particle positioned at the contact point of the objects. The determination of contact between the objects and the interaction potential between the particles of different objects will be described below with reference to FIGS. 11A and 11B.

Next, the force acting on the particles is calculated based on the position of the particle after the time evolution (step S674). In this case, the force generated based on the interaction potential between the particles is calculated only for the particle pairs AB and BC (FIG. 5) to be processed in the first loop L1. Further, for a particle on which external forces such as gravity and a load provided as a boundary condition acts, these external forces are calculated. For the particle pairs to be processed in the second loop L2 to the fourth loop L4, the force based on the interaction potential is not calculated. When the equation of motion is solved for each particle, the calculation is performed based on a combined force obtained by combining the forces acting on the particles.

When the force acting on the particles is obtained, the equation of motion is solved for each of the particles A, B, and C constituting the particle pairs AB and BC to be processed in the first loop L1 to perform the time evolution of the velocity of the particles by half of the time step width Δt₁ (step S675). In each step of S671 and S675, the time evolution of the velocity of the particles is performed by half of the time step width Δt₁. Therefore, the time evolution of the velocity of the particles is performed by the time step width Δt₁.

FIG. 8A is a flowchart showing a processing procedure of step S66 (FIG. 6). First, the force acting on the particles is calculated (step S661). In this case, the force generated based on the interaction potential between the particles is calculated only for the particle pairs BD, BE, and CE (FIG. 5) to be processed in the second loop L2. When the force acting on the particles is obtained, the equation of motion is solved for each of the particles B, C, D, and E constituting the particle pairs BD, BE, and CE (FIG. 5) to be processed in the second loop L2 to perform the time evolution of the velocity of the particles by half of the time step width Δt₂ (step S662). In two steps of S65 (FIG. 6) and S662, the time evolution of the velocity of the particles is performed by the time step width Δt₂.

FIG. 8B is a flowchart showing a processing procedure of step S64 (FIG. 6). Similarly to the case of step S66, the force is calculated for the particle pairs DE and DF (FIG. 5) to be processed in the third loop L3 (step S641). Thereafter, the equation of motion is solved for each of the particles D, E, and F constituting the particle pairs DE and DF (FIG. 5) to be processed in the third loop L3 to perform the time evolution of the velocity of the particles by half of the time step width Δt₃ (step S642). In two steps of S63 (FIG. 6) and S642, the time evolution of the velocity of the particles is performed by the time step width Δt₃.

FIG. 9 is a flowchart showing a processing procedure of step S62 (FIG. 6). Similar to the case of step S66, the force is calculated for the particle pairs EF and EG (FIG. 5) to be processed in the fourth loop L4 (step S621). Thereafter, the equation of motion is solved for each of the particles E, F, and G constituting the particle pairs EF and EG (FIG. 5) to be processed in the fourth loop L4 to perform the time evolution of the velocity of the particles by half of the time step width Δt₄ (step S622). In two steps of S61 (FIG. 6) and S622, the time evolution of the velocity of the particles is performed by the time step width Δt₄.

After step S622, the energy of a system to be simulated is calculated (step S623). The energy includes kinetic energy of the particles, elastic energy of the particle pairs, contact energy between the objects, and input and output energy which is input and output between the outside and the system. Due to the law of conservation of energy, a sum of the pieces of energy is substantially constant. Conversely, when the sum of the pieces of energy is substantially constant, the simulation result is assumed to be normal.

After step S623, the simulation result is output to the output unit 22 (FIG. 1). The information output to the output unit 22 may include, for example, a temporal change in the shape of the simulation target object, a temporal change in a position of a representative particle, a temporal change in energy obtained in step S623, and the like.

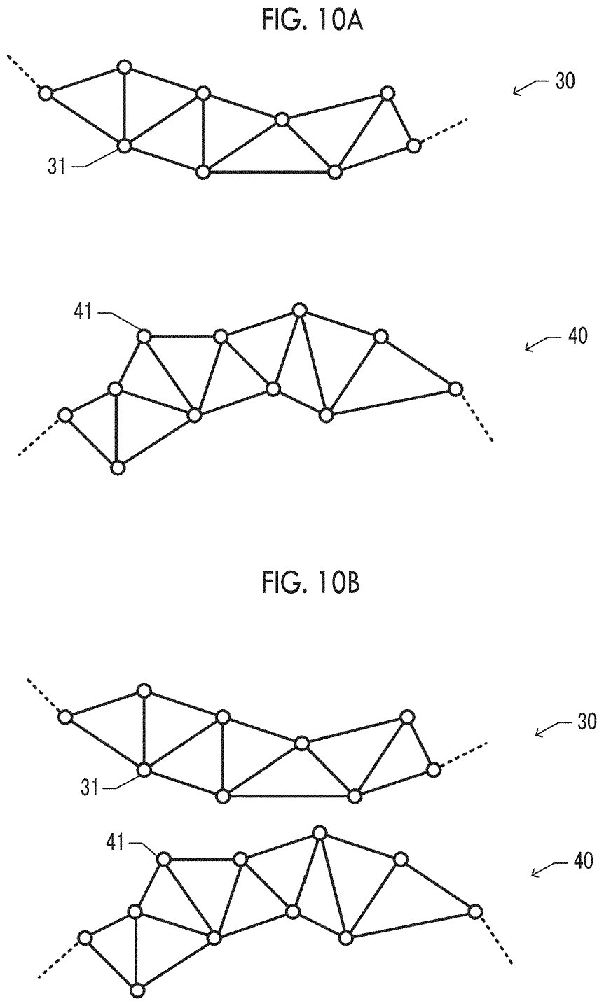

Next, the method of determining the presence or absence of contact between the objects (step S673 in FIG. 7) will be described with reference to FIGS. 10A and 10B.

FIG. 10A is a diagram showing shape models of two objects to be simulated. The shape model of one object 30 is represented by an aggregate of a plurality of particles 31, and the shape model of the other object 40 is represented by an aggregate of a plurality of particles 41. When the object 30 and the object 40 are not in contact with each other, the particles 31 constituting the one object 30 and the particles 41 constituting the other object 40 do not interact with each other.

Whether the two objects 30 and 40 are in contact with each other can be determined based on, for example, information on a distance between a surface of the one object 30 and a surface of the other object 40.

FIG. 10B is a diagram showing shape models in a state where the object 30 and the object 40 are in contact with each other. The distance between the surfaces of the two objects 30 and 40 is shorter than in the case of FIG. 10A.

Next, when the two objects 30 and 40 are in contact with each other, the interaction between the particles 31 constituting the shape model of the one object 30 and the particles 41 constituting the shape model of the other object 40 will be described.

When the objects 30 and 40 are in contact with each other, a spring-mass potential is adapted as the interaction potential such that a repulsive force acts between the particles 31 and 41 near the contact point. The spring constant is determined by how much a biting amount between objects (calculation error) can be allowed. When the calculation error can be allowed, the spring constant can be reduced.

When the time evolution of the velocity of each particle is performed, the interaction potential is considered for the particles 31 and 41 near the contact point. The time step width Δt for the time evolution is determined based on the natural period in the same manner as the particle pair in the same object. Determination is made that the calculation of the time evolution of the velocity and the calculation of the force for a pair of the particles 31 and 41 are performed by which of the first loop L1 to the fourth loop L4 based on the natural period.

Next, an excellent effect of the embodiment will be described. In the above embodiment, the time step width of time evolution is set according to the natural period for each particle pair based on a plurality of particles constituting the shape model to be simulated. In a region where the distance between the particles is long, the mass assigned to each of the particles is large since the distribution density of the particles is small. For the reason, the natural period becomes long. That is, the natural period of the particle pair depends on the distance between the particles. Therefore, it can be said that the setting of the time step width according to the natural period in the above embodiment is to set the time step width according to the distance between the particles.

As described above, since the time step width is increased for the particle pair having a relatively long distance between particles in one shape model, it is possible to reduce the calculation load as a whole. Further, since the time step width is determined based on the natural period of the particle pair, it is possible to easily determine a preferable time step width as compared with the case where the time step width is determined by trial and error.

In the above embodiment, considering the contact of two objects, the time step width of the time evolution adapted to the contact point is determined by the same method as the time step width adapted to the particle pair in the object. For this reason, it is possible to reduce the calculation load also when the above embodiment is adapted to a simulation relating to a many-body contact of a mechanism structure system.

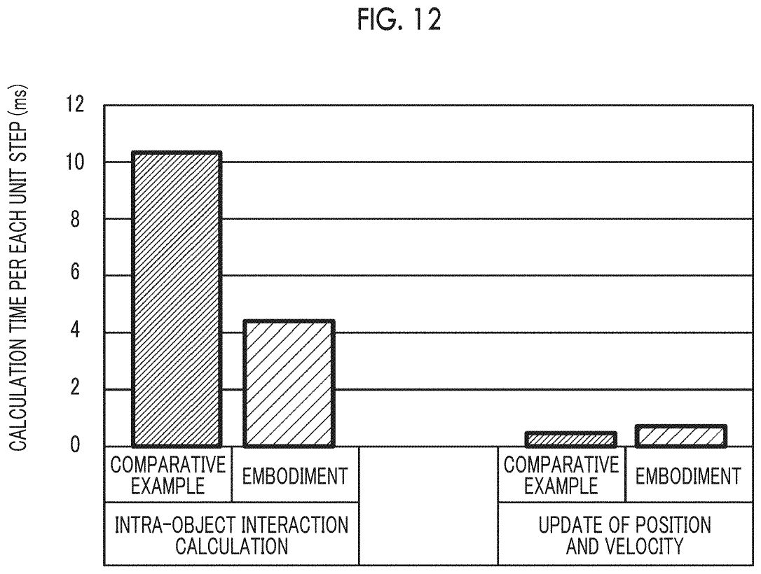

Next, a simulation performed to verify the effects of the above embodiment will be described with reference to FIG. 11A to FIG. 12.

FIG. 11A is a schematic perspective view of a verification model. A temporal change in the shape of a plate-like member is simulated in a state where one end portion 50 in the longitudinal direction of the plate-like member that is long in one direction is fixed and a load 52 in the thickness direction is applied to the other end portion 51. That is, a model in which the load 52 is applied to the tip of a cantilever structure is employed as the verification model. The mesh size is relatively reduced near the fixed end portion 50. The number of mesh nodes (particles) is 15,283, and the number of particle pairs is 93,740.

Three different time step widths are set to perform the time evolution of the state of the particle. The time step widths are denoted as Δt₁, Δt₂, and Δt₃ in ascending order. The time step widths Δt₂ and Δt₃ are respectively set to 2 times and 4 times Δt₁. It is possible to adapt the time step width Δt₃ to about 60% of the particle pairs and the time step width Δt₂ to about 25%. The time step width Δt₁ is adapted to the remaining about 15% of the particle pairs. For comparison, a simulation by a comparative example in which the time step width Δt₁ is adapted to all the particle pairs is also performed.

FIG. 11B is a graph showing a simulation result of the temporal change in a position of the unfixed end portion 51 (FIG. 11A) of the verification model. The horizontal axis represents time in the unit “ms”, and the vertical axis represents the position in the unit “mm”. In the graph of FIG. 11B, solid circle symbols and white circle symbols respectively indicate the simulation results of the embodiment and the comparative example. It is confirmed that both of the circle symbols substantially overlap each other and the same accuracy as in the comparative example is obtained in the embodiment.

FIG. 12 is a graph showing the calculation time per one time step required for an intra-object interaction calculation and a position and velocity calculation in comparison between the embodiment and the comparative example. The intra-object interaction calculation corresponds to the force calculation performed for each particle pair (step S674 in FIG. 7, step S661 in FIG. 8A, step S641 in FIG. 8B, and step S621 in FIG. 9). The position and velocity calculation corresponds to the calculations of the time evolution of the velocity and the time evolution of the position.

In the case of the model shown in FIG. 5 as an example, the particle E is included in the particle pairs CE and BE corresponding to the second loop L2, the particle pair DE corresponding to the third loop L3, and the particle pairs EF and EG corresponding to the fourth loop L4. For this reason, the time evolution of the velocity of the particle E is performed in all the second loop L2, the third loop L3, and the fourth loop L4. Therefore, in the processing of performing the time evolution of the position and velocity, a calculation time of the embodiment is longer than a calculation time of the comparative example.

In the intra-object interaction calculation, since the time step width is increased for many particle pairs, the calculation time of the embodiment is reduced to about 40% of the calculation time of the comparative example. Regarding the entire calculation time including the update of the position and velocity, the calculation time of the embodiment is about 46% of the calculation time of the comparative example. It is confirmed that the calculation time can be reduced as compared with the comparative example by adapting the simulation method according to the embodiment.

Next, a modification example of the above embodiment will be described. In the above embodiment, the four kinds of time step widths Δt₁, Δt₂, Δt₃, and Δt₄ are used as the time step width Δt based on the natural period. However, the time step widths may be two kinds or more.

The above embodiment is an example, and the invention is not limited to the above embodiment. For example, it is apparent to those skilled in the art that various changes, improvements, combinations, and the like can be made.

It should be understood that the invention is not limited to the above-described embodiment, but may be modified into various forms on the basis of the spirit of the invention. Additionally, the modifications are included in the scope of the invention.

What is claimed is:

1. A simulation apparatus comprising:
an input unit that receives shape definition data that defines a shape of a simulation target object and a mesh division condition relating to a mesh size when a mesh division of the simulation target object is performed; and
a processing unit that performs the mesh division of the simulation target object based on the shape definition data and the mesh division condition which are input to the input unit and disposes a particle at a node of a generated mesh to perform time evolution of a state of the particle based on an interaction potential between the particles,
wherein the processing unit varies a time step width for the time evolution of the state of the particle according to a distance between the particles.

2. The simulation apparatus according to claim 1,
wherein the processing unit
determines an interaction potential between the particles and mass of the particle based on a physical property value representing a degree of elasticity of the simulation target object, a density of the simulation target object, and a shape of the generated mesh, and
determines the time step width for each particle pair based on a period of a natural vibration period obtained from the interaction potential between the particles and the mass of the particle.

3. The simulation apparatus according to claim 1,
wherein the simulation target object includes a plurality of objects, and
wherein the processing unit
determines whether there is a contact between the objects by time evolution, and
when determination is made that there is a contact between the objects, determines the time step width for the particle positioned at a contact point based on a period of a natural vibration obtained from mass of the particle disposed at the contact point and an interaction potential between the particles.

4. A simulation method comprising:
performing a mesh division of a shape of a simulation target object and disposing a particle at a node of a generated mesh; and
varying a time step width for time evolution of a state of the particle according to a distance between the particles to perform the time evolution of the state of the particle based on an interaction potential between the particles.

5. A non-transitory computer readable medium storing a program that causes a computer to execute
a function of acquiring shape definition data that defines a shape of a simulation target object and a mesh division condition relating to a mesh size when a mesh division of the simulation target object is performed;
a function of performing the mesh division of the simulation target object based on the shape definition data and the mesh division condition which are input to the input unit and disposing a particle at a node of a generated mesh to perform time evolution of a state of the particle based on an interaction potential between the particles; and
a function of varying a time step width for the time evolution of the state of the particle according to a distance between the particles.
